(19) United States
(12) Patent Application Publication
(10) Pub. No.: US 2006/0161626 A1
(43) Pub. Date: Jul. 20, 2006

(54) Systems and methods for management and delivery of messages in a centralized notification system

(76) Inventors: Donald Michael Cardina, Lawrenceville, GA (US); Charles Martin Link II, Atlanta, GA (US); Purnachandra Babu Cheekati, Alpharetta, GA (US)

Correspondence Address: ZAGORIN O'BRIEN GRAHAM LLP, 7600B N. CAPITAL OF TEXAS HWY., SUITE 350, AUSTIN, TX, 78731, US

(21) Appl. No.: 10/751,764

(22) Filed: Jan. 5, 2004

Related U.S. Application Data
(60) Provisional application No. 60/527,373, filed on Dec. 5, 2003.

(51) Int. Cl. G06F 15/16; G06F 15/173

(52) U.S. Cl. 709/206; 709/239

(57) ABSTRACT

Systems and methods for providing centralized notification for over the air programming. The centralized notification system includes a central server that generates a message to be delivered to a mobile device. The centralized notification system includes an active server in communication with the central server that receives the message from the central server. The active server communicates with a network element that communicates with the mobile device. The active server queries the network element to determine availability of the mobile device. If the availability of the mobile device is returned from the network device, the message is directly routed to the mobile device, otherwise, the message is routed to a passive server. The passive server monitors message traffic for an event that provides availability information about the mobile device and automatically delivers the message to the mobile device in response thereto.

### BACKGROUND OF THE INVENTION

1. Field of the Invention

The present invention relates in general to systems and methods for maintaining, managing and distributing a message in a centralized notification system, and in particular, to monitoring message traffic to detect a triggering event from which availability of a mobile device may be determined.

2. Description of the Related Art

In today's competitive wireless business environment and with the new capability of phones, cellular phone carriers are forced to select a preferred roaming carrier when a subscriber's cellular phone is roaming. Conventionally, the method used to select the preferred roaming carrier is to have a wireless device, such as a wireless telephone contain a database of potential roaming systems. Each roaming system can be tagged as home, preferred, neutral, non-preferred, or barred, etc. Once the wireless device locks onto a system, and identifies the system, the database contained within the wireless device is consulted for operation preference and reselection is made as necessary. Generally, this database is contained in a non-volatile memory of the wireless device. It can be preloaded at time of manufacture or loaded at activation time and potentially reloaded periodically as inter-carrier roaming agreements are changed. Potentially the phone can be returned to point of purchase for the update of this database, but over-the-air updates are more convenient and facilitate transparent (to the subscriber) and more frequent updates.

The traditional method of an over-the-air update is via a special short message (SMS) that contains specific codes that cause the message to be loaded as an Intelligent Roaming Database (IRDB). The traditional method for sending an SMS message is to first locate the system serving the wireless device and then deliver a message to that serving system for further delivery by the system to the wireless unit. Typically this functionality is part of the short messaging service center (SMSC) 500. FIG. 8 illustrates a conventional diagram of a message routing process using an SMSC.

FIG. 8 shows a system server 400 communicating with a SMSC 500, which in turn communicates with signal transfer point (STP) 600. The STP 600 communicates with a mobile switching station (MSC) 700 and a home location register (HLR) 800 in which a mobile device 900 is served. Traditionally, there are at least 4 steps that must occur so that messages can be generated before the particular system server 400 can determine the location of a mobile device 900. Thereafter, the system server 400 can instruct the SMSC 500 to download the message to the mobile device 900.

In a first step (S1), a short message (SMS) request is generated and is sent from the SMSC 500 to the HLR 800 in which the SMS requests the address of the serving switch of the mobile device 900. In step two (S2), the HLR 800 returns a result back message to the SMSC 500 identifying the serving MSC 700 where the particular mobile device 900 can be located in the network. In step 3 (S3), the SMSC 500 generates a short message delivery point-to-point (SMDPP) and sends the SMDPP to the MSC 700 serving the mobile device 900. In step 4 (S4), the MSC 700 generates a return result message and sends the return result message back to the SMSC 500 confirming the delivery of the message to the mobile device 900.

As illustrated, this conventional process takes at least 4 steps and requires the HLR 800 to be queried for the address of the serving switch. These steps are time consuming,and resource intensive on the signaling network, STP 600 and especially HLR 800.

An additional disadvantage of the traditional delivery process is that numerous attempted deliveries are unsuccessful. The traditional delivery process has no knowledge of the mobile device availability. Therefore, delivery attempts will be initiated without respect to whether the mobile device is within radio coverage. This attempt wastes not only network resources, but also wastes radio frequency spectrum bandwidth, by signaling the mobile device that is out of radio range or was inadvertently turned off due to low battery. If the mobile device is powered off normally, it notifies the network elements prior to the power off. A traditional delivery would still waste the network resources discovering the mobile device was powered off.

Based on the frequent need for updates, the expanded roaming partner list, and the method of conventional delivery plus the proliferation of revenue generating SMS messages, the demand on the network (on SMSC 500, STP 600, HLR 800, and MSC 700) has been exceeding the available network bandwidth. Additionally, the radio frequency spectrum bandwidth requirements are being taxed to make delivery attempts that are not successful. Thus, it is an object of this invention to reduce the inefficient load on the STP 600, HLR 800 and MSC 700 and the RF network, while ensuring the efficient management of network resources and the distribution of messages in an expedient manner.

### SUMMARY OF THE INVENTION

An object of the invention is to provide systems and methods for providing administration, management and delivery of administrative and other non-conventional non-time critical messages utilizing a centralized notification (CNOT) system, and in particular to provide delivery and management of IRDB's and public land-mobile network (PLMN) lists for Global System for Mobile communication (GSM) wireless devices.

Another aspect of this invention is a CNOT system that drastically reduces and/or eliminates the load on the signaling network as well as the RF network.

Another object of the invention is to provide a system that includes a central server that generates a message to be delivered to a mobile device. An active server is in communication with the central server and receives the message from the central server. The active server communicates with a network element which in turn communicates with the mobile device. The active server queries the network element to determine availability of the mobile device. If the availability of the mobile device is returned as available, from the network device, the message is directly routed to the mobile device; otherwise, the message is routed to a passive server. The passive server monitors message traffic for an event that provides availability information about the mobile device and automatically delivers the message to the mobile device in response thereto.

Another aspect of this invention is to passively receive echo registrations based on registrations generated from the mobile device. Availability information about the mobile device can be determined from receipt of the echo registrations. For example, when a mobile device registers with a serving MSC through a cell site, a message is sent back to an HLR through an STP. The HLR then sends return results back to the MSC. According to systems and methods of this invention, the HLR also sends a mobile registration trigger (MRT) containing the availability information back to the CNOT system. The MRT is the echo registration, or copy of the registration from the mobile device.

Another object of the invention is to log the attempted results of the delivery of the message in a history database that may be reviewed in the future.

Another object of the invention is to provide a method for managing over the air programming to a mobile device. The method includes generating a message in a central server that is to be downloaded to the mobile device, and delivering the message to an active server. Then, a network element is queried for availability information about the mobile device. If the availability of the mobile device is positive, the message is directly routed to the mobile device, otherwise, the message is routed to a passive server. The passive server monitors message traffic for an event that provides availability information about the mobile device, and downloads the message to the mobile device in response to receiving the availability information.

According to systems and methods of this invention, the CNOT system manages preferred PLMN lists, for example, stored in a subscriber identity module (SIM) card required for GSM or GSM ANSI Interoperability Team (GAIT) subscribers, and/or roaming file/data for various other technologies. A GAIT phone is a GSM phone with Time Division Multiple Access (TDMA) characteristics. In particular, a GAIT phone is a combination phone that operates as if it is on a home system equally on either the original European developed GSM air interface and the US developed IS-136 air interface (or TDMA). The GAIT phone operates as if it is on a home system on either a GSM HLR or a TDMA HLR. The GAIT phone has a SIM module like a GSM phone and it also has an electronic serial number (ESN) number like a TDMA phone. The GAIT phone can be set up to prefer GSM or to prefer TDMA.

These and other objects, features, and/or advantages may accrue from various aspects of embodiments of the present invention, as described in more detail below.

### BRIEF DESCRIPTION OF THE DRAWINGS

Various exemplary embodiments of this invention will be described in detail, wherein like reference numerals refer to identical or similar components or steps, with reference to the following figures.

FIG. 1 is an exemplary diagram of a centralized notification (CNOT) system in accordance with systems and methods of this invention.

FIG. 2 is a detailed exemplary diagram of a passive server in the CNOT system in accordance with systems and methods of this invention.

FIG. 3 is a detailed exemplary diagram of an active server in accordance with systems and methods of this invention.

FIG. 4 is a detailed exemplary diagram of a passive server in accordance with systems and methods of this invention.

FIG. 5 is an exemplary method for the CNOT system implementing an active server and a passive server in accordance with systems and methods of this invention.

FIG. 6 is an exemplary method for the CNOT system implementing a passive server in accordance with systems and methods of this invention.

FIG. 7 shows an exemplary log file in accordance with systems and methods of this invention.

FIG. 8 is a diagram of a message routing process using a conventional SMSC.

### DETAILED DESCRIPTION OF EXEMPLARY EMBODIMENTS

Particular embodiments of the present invention will now be described in greater detail with reference to the figures.

To solve the problems described above with respect to conventional delivery using traditional SMSC's, and to increase capacity to program administrative-type short messages, a centralized notification (CNOT) system is provided as described below.

This invention overcomes the conventional problems described above by providing a CNOT system that provides management and delivery of messages, including for example, intelligent roaming database (IRDB) messages or welcome messages. In particular, one aspect of this invention is management of delivery of IRDB information to mobile devices 9. Availability of a mobile device 9 may be determined by the CNOT system in response to a triggering event. For example, in response to the notification of the availability of the mobile device, the CNOT system downloads a database that directs the mobile device 9 to route a call on the lowest price carrier available, as prescribed by a hierarchical list in the IRDB for that particular mobile technology on mobile device 9. The preferred lowest price carrier is selected based on contracts negotiated by the carrier. It is an object of the carrier to select the preferred lowest price carrier that offers the lowest fee per minute on which the subscriber's mobile device may roam. An entry for the preferred lowest price carrier is placed in the IRDB. The preferred lowest price carrier may vary from market to market based on the lowest price offered in a particular market by competing carriers.

In accordance with systems and methods of this invention, a message is a sequence of characters arranged in a particular format that is used to convey information or data. Any type of message, including various types of data, may be communicated in accordance with systems and methods of this invention. Some exemplary types of messages programmed and delivered in accordance with systems and methods of this invention include: welcome messages, intelligent roaming database (IRDB), short messages, multimedia messages, preferred PLMN messages, forbidden PLMN messages, PLMN selector messages, customer services profile messages, and any other type of message capable of operating with the CNOT system. The message may include various types of information, such as a mobile identification number (MIN), point codes, an intelligent roaming database number (IRDP), system Identification code (SIC), system operator code (SOC) alone or combined as a HEX string, alpha tags, administrative text messages, voice mail notification messages, games, trivia and/or any other type of information associated with the cellular system.

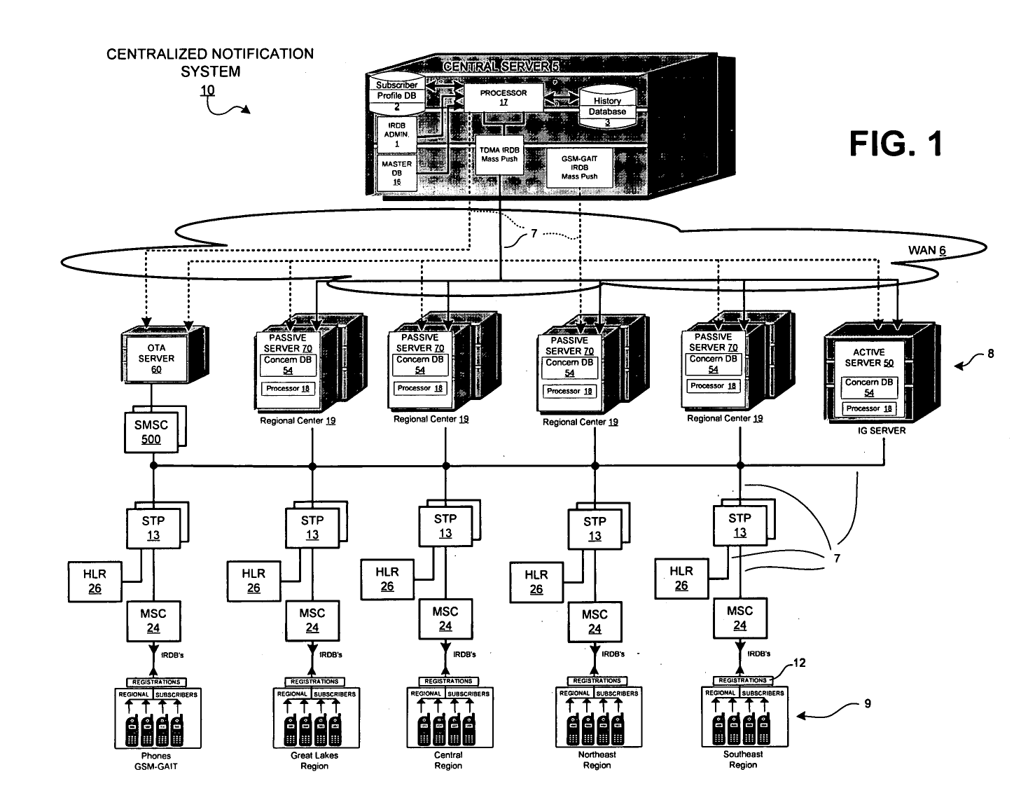

FIG. 1 is an exemplary illustration of the CNOT system 10. The CNOT system 10 is adapted to manage and distribute messages, such as IRDB information or other message types to the mobile at various predetermined times, for example, at activation, and/or when a mass update is required.

The CNOT system 10 includes a central server 5 that communicates with an intelligent roaming database administrator (IRDBA) 1 and a subscriber profile database 2. The IRDBA 1 and the subscriber profile database 2 may be incorporated as part of, or separate from, the central server 5. The central server 5 is connected to various remote servers 8 (also referred to as nodes), each of which has a different purpose.

In particular, FIG. 1 shows an active server 50, at least four passive servers 70 possibly located in at least four regional centers 19, and an over the air (OTA) server 60 provided for communicating messages to a subscriber identity module (SIM) card in GSM phone. Any number of servers 8 may be implemented in various possible configurations (for example, more or less passive servers 70 may be provided based on requirements, such as for accelerating delivery of messages) in accordance with systems and methods of this invention.

FIG. 1 shows the central server 5 communicating via a wide area network (WAN) 6, such as a TCP/IP wide area network, to the remote servers 8. The remote servers 8 communicate with switching transfer points (STP's) 13, which in turn communicate with home location registers (HLR's) 26 and mobile switching centers (MSC's) 24, which communicate with various mobile devices 9. The term mobile device includes any type of wireless device, including cellular telephones, wireless enabled PDA's, interactive pagers, satellite terminals or any other device that communicates to a central network via bidirectional communications.

The communication links 7 (shown in “solid” lines) illustrate a first technology, such as time division multiple access (TDMA), and the “dash” lines illustrate portions of a second technology, such as GSM-GAIT, that operate in combination with the first technology. FIG. 1 may include any suitable type of communication link capable of transferring information between the various components in accordance with systems and methods of this invention. For example, the communication link 7 may be a TCP/IP connectivity link, a signaling system 7 (SS7) connectivity link, a fiber channel, a wireless signal, and/or any other type of communication link now known or later developed.

In operation, the active server 50 actively seeks out and determines the availability of a mobile device 9 so that the active server 50 may deliver a message to the mobile device 9 at the time the message is ready to be delivered. For purposes of this specification, the term “availability” will be used to incorporate the minimal amount of information a carrier requires to deliver an over-the-air message information to a mobile device, and may include, for example, availability information (such as presence and location information), network information, account status, or any other type of information in that regard. This is particularly useful during activation of a mobile device 9. The active server 50 may be located adjacent to, or remote from, the central server 5. The active server 50 implements real time processing. The active server 50 performs the functions of an SMSC in order to determine the availability of the mobile device 9 and deliver message thereto. Thus, it operates like the SMSC 500.

It is one aspect of this invention to directly route a message to a mobile device 9. As mentioned above, an example of an instance where an immediate delivery is likely is during activation, i.e. when a customer purchases a new mobile device 9. The current IRDB, as well as other pertinent provisioning information, should be downloaded to the mobile device 9 upon activation and prior to use. A customer agent may activate the mobile station 9 on a provisioning system by requesting a message to be sent through the CNOT system network to modify information stored by the mobile device 9.

Modes for Delivering Messages

There are at least three modes in which a message may be routed to a mobile device 9. First, messages may be delivered directly by the active server 50 actively seeking out a target mobile device 9, and subsequently delivering the message to the target mobile device 9. Second, upon unsuccessful delivery by the active server 50 over a specified period of time, the active server 50 routes the undelivered message to a passive server 70 for delivery. After the passive server 70 receives the instructions to route the message to the mobile device 9, the passive server 70 passively waits for a triggering event to occur from which availability of the mobile device 9 may be determined before it may determine where to deliver the message. Third, messages may be directly routed to the passive servers 70 from the central server 50 for delivery, bypassing the active server 50, with the passive server 70 waiting on the triggering event for the mobile device 9 availability prior to a delivery attempt.

An example of the first mode of delivery occurs during activation of a mobile device 9. During activation, the active server 50 actively seeks out the availability of the mobile device 9 so that the active server 50 can directly deliver the activation message to the mobile device 9. The active server 50 will actively attempt to locate the mobile device 9 at the time the message is ready to be delivered. If the mobile device 9 is located, the active server 50 will deliver the message. Otherwise, according to the second mode, the active server 50 will send the message to a passive server 70.

According to the second mode, delivery occurs after the active server 50 has attempted and failed to deliver the message, the message is delivered to the passive server 70 and the passive server 70 then takes over the process of attempting to-deliver the message to the mobile device 9.

According to the third mode for delivering messages, messages may be generated by the central server 5 and directly routed to the passive servers 70, bypassing the active server 50. This mode is similar to the second mode minus the prior interaction by the active server 50.

Referring to the first mode of delivery in more detail, the active server 50 will actively determine the availability of a mobile device 9. The availability, namely presence and location of a mobile device 9 may be determined by the active server 50 in the following manner.

As is known in the art, registration of a mobile device 9 typically occurs at three different times, i.e., at power up of the mobile device 9, power down of the mobile device 9, and automatically at predetermined intervals as defined by the serving MSC. The availability state of the mobile device 9 is stored in the HLR 26. As will be appreciated by those skilled in the art, a mobile device 9 registers with the MSC 24 and ultimately the HLR 26.

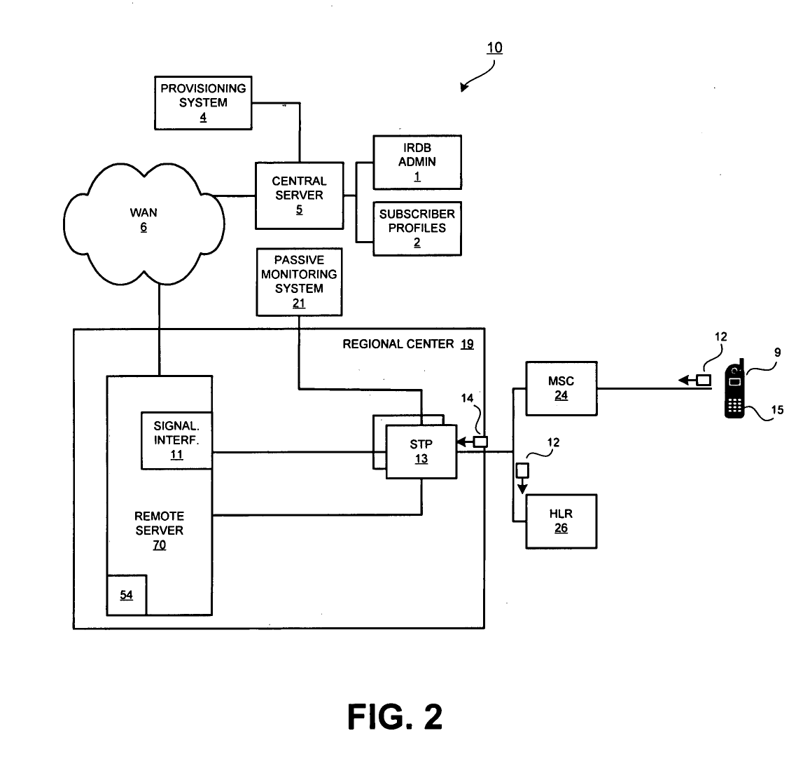

Referring to FIG. 2, according to the present invention, when a mobile device 9 registers (by transmitting a registration 12) with the MSC 24, the MSC forwards the registration 12 to HLR 26 via the STP 13. This registration 12 contains the address of the serving system (or MSC) that is currently serving the mobile device 9. The HLR 26 receives the registration 12 from the STP 13 and stores the availability information in a record of the mobile device 9. This availability information stored in the record includes the address of the serving system. When the active server 50 needs to deliver a message to the mobile device 9, it requests the availability information from the HLR 26. After determining that the mobile device 9 is available and the address of the serving system, active server 50 can deliver a message to the mobile device 9. In this manner, the active server 50 operates like a conventional SMSC 500.

If, for some reason, the last location is different from the current location of the mobile device 9, then the active server 50 can also operate similar to a conventional SMSC and retry the delivery attempt later. The active server 50 may make a predetermined number of attempts to locate the mobile device, and thereafter abandon its attempts.

If, after the predetermined number of attempts, the active server 50 is still unsuccessful in delivering a message to mobile device 9, a return result will be returned to the central server 5 informing the central server 5 of its unsuccessful attempts. The unsuccessful attempts will be logged in the history database 3. The attempts to deliver may be unsuccessful where the mobile device 9 is powered off. The central server 5 may then instruct the active server 50 to route the message to a passive server 70 that is designated as serving an area where the mobile device 9 is homed. “Homed” is defined as the mobile device's home network area.

However, if the return result is successful in locating the mobile device 9, the active server 50 may deliver the message to the mobile device 9 and inform the central server 5 of the results. Among various other possible parameters, instructions included with the message may update the IRDB 15 (as shown in FIG. 2) in the mobile device 9 with the most recent roaming operating instructions. After successful delivery, the central server 5 will then receive a message log file in which the central server 5 is notified that the IRDB 15 of the mobile device 9 has been updated. The message log file is stored in the history database 3.

Referring to the second mode for delivery of a message in more detail. The passive server 70 takes over the process of attempting to deliver the message to the mobile device 9 after the active server 50 has failed to deliver the message. The task of the passive server 70 is to deliver the message in response to a triggering event (such as receiving an echo registration 14 when the mobile device 9 registers with the HLR 26). This registration includes availability information (e.g., the presence and location) of the mobile device 9. Although possible, the passive server 70 will not actively seek out the mobile device 9, as described above with respect to the active server 50. Instead, the passive server 70 will passively wait until the triggering event occurs that provides availability information about the mobile device 9, such as the mobile device 9 registering with the serving MSC 24.

For exemplary purposes, in FIG. 2, the triggering event in which the availability of the mobile device 9 may be determined is that of receiving registrations 12 from mobile devices 9. In particular, when the registration 12 is received by the HLR 26, either at power up, or at predetermined times, the echo registration 14 (or copy of the registration 12 that is routinely sent to the HLR 26) is generated by the HLR 26 and is also automatically sent to the STP 13 and made available to the passive server 70. Availability information is extracted from the echo registration 14 about the mobile device 9, for example, a mobile identification number (MIN) may be extracted. The MIN from the echo registration 14 is compared against a list of MIN's stored in a concerned database 54 (which identify specific mobile devices 9 that require updating).

If a MIN in the concerned database 54 matches the MIN of the echo registration 14, the passive server 70 may then build a message, such as an IRDB message. The CNOT system 10 may use existing template tables to maintain IRDB's. Other parameters may be used to combine and build the message, such as ESN tables that may be used to make determinations as to the type of IRDB that the mobile device 9 is to receive (i.e., dual, single, enhanced). The passive server 70 will then attempt to automatically deliver the message to the mobile device 9. Once the IRDB message is delivered to the mobile device 9, the passive server 70 may then inform the central server 5 that the mobile device 9 has been updated. The information delivered to central server 5 may include information, such as, the MIN, ESN, date, time, the IRDB template and the serving system (or MSC 24 serving the mobile device 9) where the message was delivered to the mobile device 9. The information may then be stored in the history database 3 of the central server 5.

In the alternative, prior to delivering the message to the mobile device 9, a notification can be sent to the central server 5 before the passive server 70 delivers the message to the mobile device 9. The central server 5 can provide the authorization to route the message to the mobile device 9, and/or additional instructions prior to delivery of the message to the mobile device 9.

In a preferred embodiment, the passive servers 70 may be directed to various regional markets located around the country. It is to be understood that the passive servers 70 may also be distributed in a regional network or a worldwide network. The passive servers 70 and the active server 50 are similarly configured. Each of the passive servers 70 is adapted to receive availability information, for example, echo registration 14 (e.g., IS 41 registration messages, or GSM MAP update location messages) in each of their respective regions in which the mobile devices 9 are homed or are roaming.

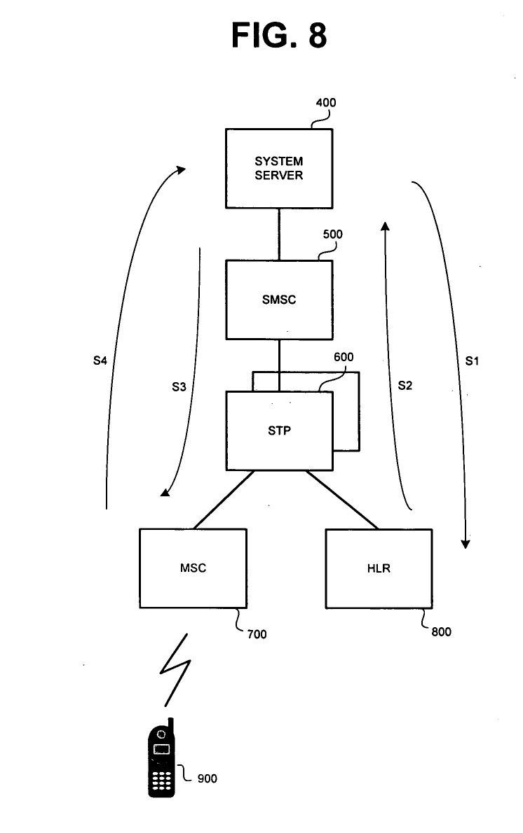

According to systems and methods of this invention, costs and resources surrounding the use of the network are minimized by automatically obtaining availability information (e.g., presence and location) from triggering events that occur in the CNOT system 10 without having to query the HLR 800. As mentioned before, the message is delivered to the mobile device 9 in as few as 2 steps because it is no longer necessary for some network element to query the HLR 26 to determine the availability of the mobile device 9; unlike the conventional 4-step process described in FIG. 8.

The triggering event from which presence and location or other availability information may be derived is generated from a variety of different inputs, or feeds, arising from various triggering events that occur in the network. For example, the triggering event could include monitoring individual cell sites for availability information. This could be done, for example, by monitoring the data links between the cell sites and the MSC. Availability information may also be captured from a registration 12 that is transmitted directly from an MSC/HLR combination, e.g., a commercially available LUCENT® MSC with an integrated HLR. The triggering event could be related to other passive monitoring systems that detect availability information data related to a mobile device 9 at various locations in cellular network. For example, availability information may be obtained from an accounting server system in which the mobile device 9 is tracked for purposes of billing. The triggering event could also include independently monitoring traffic between an MSC and an HLR to obtain a registration 12. The triggering event could come from any external location device and/or platform in the network. A user may choose to proactively signify availability by initiating a service such as SMS, unstructured supplementary service data (USSD) or instant messaging. Any event from which availability information may be derived is sufficient to qualify as a triggering event according to systems and methods of this invention.

According to systems and methods of this invention, it is only necessary to generate and send a message (such as an IS-41 SMDPP, S3 as shown in FIG. 8) to the MSC 24 serving the mobile device 9, and then to wait for a return result (S4 as shown in FIG. 8) from the MSC 24 confirming or denying successful delivery of the message. The conventional 4-step (S1-S4) process described in FIG. 8 has been effectively reduced to a 2-step (similar to S3-S4) process. In addition, the CNOT system 10 provides for the direct transmission of non-revenue generating or administrative type messages (such as, voicemail notification, over the air programming, downloading of IM buddy lists, prepaid or postpaid account information, and the like) which are offloaded from the SMSC 500. This type of non-revenue generating traffic bypasses the SMSC 500 altogether and is routed directly to the serving MSC 24 via one of the servers 50, 70 of the CNOT system 10.

This reduction in the number of steps processed results in a more efficient use of the signaling system 7 (SS7) network resources by allowing selected portions of the SS7 network to be bypassed.

I. CNOT System Components/Features

Referring now to the various component parts in the CNOT system 10 in more detail. FIG. 2 is a detailed exemplary illustration of a passive server 70 in a regional center 19. The passive server 70 includes at least a concerned database 54 and a signaling interface 11. The central server 5 is connected to the intelligent roaming database administrator (IRDBA) 1 and the subscriber profile database 2. The central server 5 communicates through a wide area network (WAN) 6, such as a TCP/IP wide area network, to the passive server 70 located in a regional center 19, which in turn communicates through the signaling interface 11 to signal transfer point (STP's) 13, which in turn communicates with a mobile switching center (MSC) 24 (serving the mobile device 9) and a home location register (HLR) 26.

The CNOT system 10 may support various technologies, for example the TDMA and GSM markets. The CNOT system 10 also may support GAIT, CDMA, UMTS, and any other communication technology now known or later developed. For exemplary purposes, FIG. 1 shows the CNOT system 10 being implemented for use with TDMA and GSM-GAIT technologies.

MSC-HLR

The MSC 24 and HLR 26 arrangement may be implemented in various configurations as is known in the art. For example, the MSC 24 and the HLR 26 may be incorporated as separated units, or integrated as a single unit (such as in a commercially integrated MSC with an integrated HLR produced by LUCENT®). The HLR 26 may be located adjacent to, or geographically separated from, the MSC 24.

Intelligent Routing Database Administration (IRDBA)

The intelligent roaming database administration (IRDBA) 1 is a message manager. The IRDBA 1 is the mechanism that manages and creates subscriber profiles and databases to be loaded into the intelligent roaming database (IRDB) 15 located in the subscriber's mobile device 9. Changes by the IRDBA 1 may include, among other things, changes to the concerned database 54 located in the passive server 70 and changes to IRDB databases in the IRDBA 1. The provisioned changes are distributed through an appropriate passive server 70 to the IRDB 15 contained in a mobile device 9. The IRDBA 1 also has the capacity to maintain old databases having subscriber profiles. For example, if a subscriber profile is created today and distributed to everyone in the market, the old subscriber profile may be archived and maintained so that it may be referenced as necessary.

Intelligent Routing Database (IRDB)

The IRDB 15 is a roaming database contained in the subscriber's handset. The IRDB 15 contains a set of instructions (or list) indicating to the mobile device 9 which carrier system the mobile device 9 should roam on in a particular area. The IRDB 15 includes a relationship between System ID's (SID's) and System Operator Code's (SOC's) and associated descriptions. In TDMA, both SlD's and the SOC's are broadcast by cell transmitters. The SID's and SOC's in the IRDB 15 are organized in a hierarchical manner based on the carrier's preferences and financial opportunities, or lowest roaming operating rates, where the highest category is the carrier's own home network for example.

For example, if a user is an Atlanta, Ga. customer, then the mobile device 9 will prefer to operate on a profile created for an Atlanta based customer. This may be different from a profile set up for a customer in a different location (such as Birmingham, Ala.) because an Atlanta customer may have specific preferences in an IRDB 15 for Atlanta that would not be in an IRDB 15 configured for Birmingham, or one configured for Miami, Fla. Each market may have a specific database that is optimally designed for its particular location.

Virtually every market has its own subscriber profile and may have multiple IRDB's. For example, there may be an IRDB 15 that applies to single band phones, i.e., a phone that will only operate at a particular frequency, such as 850 megahertz. Alternatively, an IRDB 15 may be profiled to apply to dual band phones, i.e., mobile devices operating at 850 and 1900 megahertz. An IRDB 15 may be specific to particular vendor phones. A particular vendor phone may have larger IRDB 15 instructions than others. Thus, a number of profiles for each customer are possible. For example, it is possible to have ten or more different profiles for Atlanta customers. Each profile may have a slightly different number of SIDS, or band order, or some other parameter that would make the profile different. For example: a MOTOROLA® mobile device might have 512 entries in the database; an ERICSSON® mobile device might have 256 entries; and another mobile device might have 100 entries.

Subscriber Profile Database

The subscriber profile database 2 contains subscriber information, such as, a mobile identification number (MIN), an electronic serial number (ESN), a current IRDB that to be loaded to the subscriber, a desired IRDB that is desired to be loaded to the subscriber, and/or any other pertinent information relative to a profile of the subscriber.

The subscriber profile database 2 gets populated each time a change is made by an external provisioning unit 4, for example, when a change (even a minor change) in the network is made to a subscriber's profile, a message is automatically sent to the subscriber profile database 2 to update the subscriber profile.

Central Server

The central server 5 contains a master relational database 16 (FIG. 1), such as for example, an ORACLE® database. The master relational database 16 contains various types of information suitable for operation of the CNOT system 10. Various sub-databases may be provided in the master relational database 16 that contain lists of potential mobiles that require messages downloaded to their IRDB's 15. The master database contains, for example, ESN's, the electronics a mobile device 9 associates with those mobile telephone numbers, the IRDB's that need downloading to various mobile devices 9 that require updating; and any other pertinent information in accordance with systems and methods of this invention.

The central server 5 may be implemented as a single server or a combination of multiple servers and includes at least one or more processors 17. The central server 5 could operate on any generic PC or computing system processor according to systems and methods of this invention.

The central server 5 communicates with and provides instructions for the remote servers 8, 50, 60, 70 that deliver messages to the mobile devices 9. The central server 5 may host servers regionally, nationwide, and/or on a worldwide basis. The central server 5 provides support for all regions by upgrading “remote processors and disk storage units” 18 in the remote servers 50, 70. The CNOT system 10 is not limited to any particular number of remote servers 8, 50, 70, and may contain as many as necessary to efficiently perform the functions according to systems and methods of the CNOT system 10.

The central server 5 provides an audit trail of all transactions in the CNOT system 10. That is, the central server 5 monitors the transactions in each of the remote servers 8, 50, 60, 70, and logs all of the attempted delivery results to and from the servers 8, 50, 60, 70 into the history database 3. The results may be recorded in real time or at various predetermined intervals. As mentioned before, the log files include a history of all activities associated with the CNOT system 10 and are stored in the history database 3.

The central server 5 includes a suite of software application programs that handle the basic processes of delivery in the CNOT system 10. The software suite programs include application programs directed to, but not limited to: messaging Server (SMPP); Signaling Interface Module; Message Generation Module; normal delivery of messages; handling the LUCENT mobile registration trigger (MRT) registrations from the network where an MSC with an integrated HLR by LUCENT® is implemented; TCP/IP registration input module from presence awareness detecting network elements. Other programs may be included that provide boilerplate applications, which handle different functions, and operate from different directories, such as generating all the necessary information for message delivery. The CNOT system 10 could also implement a common streamlined application programming interface (API), for example, one in which IRDB templates are defined and queued in the CNOT system 10 via a web graphical user interface (GUI) directly by roaming managers. Various other application programs that perform the functions of the systems and methods of this invention may also be implemented.

Passive Servers

The passive servers 70 may be market specific. As shown in FIG. 1, more than one passive server 70 may be provided in the CNOT system 10 and distributed throughout various markets. In addition, more than one passive server 70 may be provided in each region. Each of these distributed passive servers 70 may be assigned delivery duties for a block of numbers. Delivery may be based on a variety of different duties. The delivery duties could be geographic, or the delivery duties may be based on the NPA-NXX (i.e., the first six numbers of a telephone number). The delivery duties could also be based on the MIN itself, such as where one passive server 70 may service odd MIN's, and another passive server 70 may service even MIN's. Alternatively, delivery duties may be broken out by some combination of the above described duties, and/or any other scheme for defining delivery duties.

CNOT Logging Functions

The history database 3 contains a summary of all delivery attempts performed by the servers 8, 50, 60, 70. That is, the history database 3 contains a complete audit trail of a log of files (hereafter log files) for delivery attempts, and may be viewed at any time by the CNOT system 10 delivery process. The log file may include any type of information, such as date, time, message number, IRDB template, and/or any other pertinent information. The log file may be built at predetermined intervals, for example every ten minutes, and transferred to the history database 3 in the central server 5. Alternatively, the log files can be delivered to the history database in real time. Although possible, no external user interaction is necessary. Various types of actions are logged by the log files, such as successful message delivery, unsuccessful message delivery, and any other type of activation that summarizes the attempts at delivering messages.

Processors

Remote processors 18 in each of the remote servers 8, 50, 70 could operate on any generic PC or computing system processor according to systems and methods of this invention. For exemplary purposes, the remote processors 18 in each of the remote servers 50, 70 may be a SUN NETRA® 1100 processor and/or any other processor capable of performing functions of the CNOT system 10.

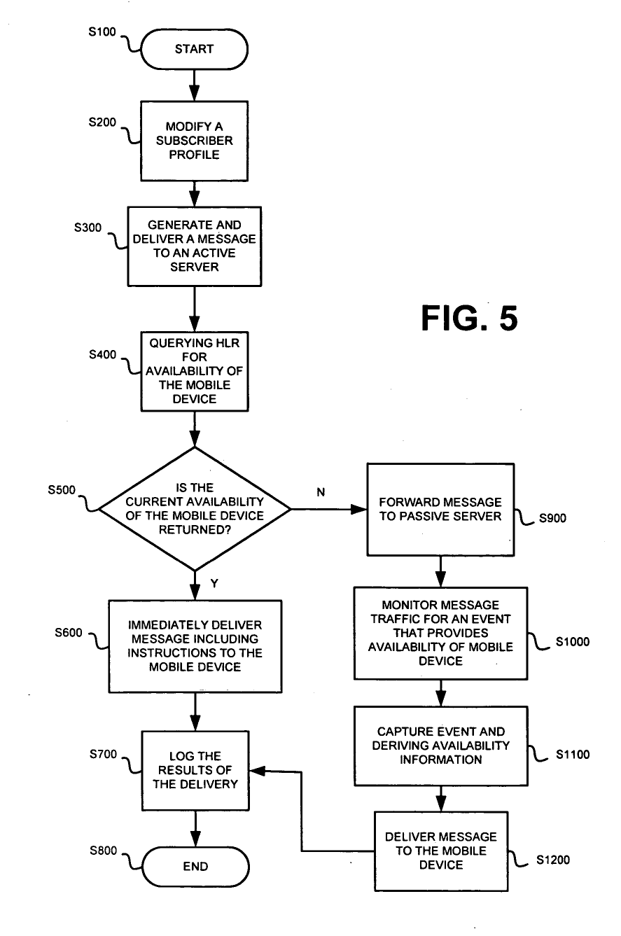

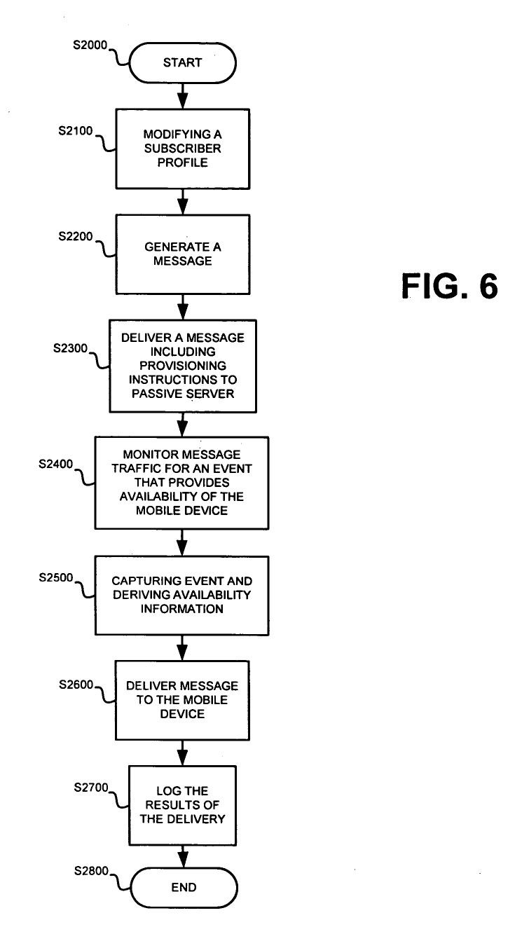

In particular, the remote processors 18 in each of the remote servers 8, 50, 70, and the processor 17 in the central server 5 may be implemented on a programmed general purpose computer. The processors 17, 18 may also be implemented on a special purpose computer, a programmed microprocessor or micro-controller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device, capable of implementing a finite state machine that is in turn capable of implementing the flowcharts shown in FIGS. 5-6 may be used to implement the systems and methods according to this invention.

The various blocks shown in FIGS. 5-6 may be implemented as portions of a suitably programmed general purpose computer. Alternatively, the various blocks shown in FIGS. 1-6 may be implemented as physically distinct hardware circuits within an ASIC, or using a FPGA, a PDL, a PLA or a PAL, or using discrete logic elements or discrete circuit elements. The particular form each of the blocks shown in the figures will take is a design choice.

The central server 5 may be implemented using any appropriate combination of alterable, volatile or non-volatile memory or non-alterable, or fixed, memory. The alterable memory, whether volatile or non-volatile, may be implemented using any one or more of static or dynamic RAM, a floppy disk and disk drive, a write-able or rewrite-able optical disk and disk drive, a hard drive, flash memory or the like. Similarly, the non-alterable or fixed memory may be implemented using any one or more of ROM, PROM, EPROM, EEPROM, an optical ROM disk, such as a CD-ROM or DVD-ROM disk, and disk drive or the like.

Referring to FIG. 2, the signaling interface 11 is disposed between the passive server 70 (or the active server 50) and the STP's 13. The signaling interface 11 could also directly connect to the STP's using TCP/IP “A-Links” or SIGTRAN. The signaling interface 11 is a switching unit that can support multiple protocols; either individually (such as for example only IP connectivity) or various at a time (such as for example, IP and SS7 connectivity). For example, the signaling interface 11 may be employed as an IP-SS7 converter to provide a bridge between an IP and an SS7 network. The signaling interface 11 may be provided to establish a connection directly to the STP 13 via internet protocol IP. SS7 messages may be encapsulated in the IP message. In this instance, the signaling interface 11 may strip out the IP portion of this message. The IP portion may then be converted to an SS7 message and impressed upon the network via SS7 links. Various other methods may be provided to implemented SS7 connectivity via SS7 links.

For example, low speed SS7 links may be provided coming out of the back end of the signaling interface 11. The signaling interface 11 may be any type of commercially available gateway capable of generating messages that may be communicated from the passive server 70 through the SS7 to the MSC 24, such as an IP-SS7 converter made by TEKELEC®, MICRO LEGEND®, CISCO®, and any other commercially available IP to SS7 router/converter now known or later developed that is capable of providing IP to SS7 conversions in the CNOT system 10. Alternatively, the signaling interface 11 may be implemented having an imbedded portion of the STP 13. The signaling interface 11 may also be SS7 could be an embedded part of the passive and active servers.

Signal Transfer Point (STP)

The STP 13 provides for the transfer of signalling messages from one signalling link to another signalling link in a common channel signalling network. According to systems and methods of this invention, the STP 13 is adapted to receive echo registrations 14 based on triggering events from a mobile device 9. The STP 13 may be in communication via, for example, low speed SS7 links, high-speed SS7 links, IP connectivity and/or any other communication link now known or later developed for use in accordance with this invention.

Triggering Events

Various components may be implemented as part of the CNOT system 10 from which triggering events may be received to provide availability (presence and location) of a mobile device 9. Triggering events may be provided by a number of possibilities, such as receiving a registration 12 when a mobile device 9 registers with the HLR. Other examples from which triggering events could be received include, for example, an external provisioning unit 4, an MSC with an integrated HLR and/or any other component capable of generating and/or receiving triggering events.

Additional methods for acquiring availability information include, for example: 1) mobile registration triggers (MRT); 2) a passive monitoring system contained in system tied onto the links passively, containing SS7 monitoring capability, 3) a feed from a commercially available SS7 monitoring system (such as AGILENT acceSS7®, or INET Geoprobe®; 4) a mechanism where every piece of traffic passing through the STP is echoed to a TCP/IP port where it is forwarded to another processor (i.e. MAS); and 5) and all necessary SS7 messages such as IS-41 Registrations GSM MAP Update Location messages, and the like are filtered and sent to the CNOT passive server.

FIG. 2 shows a passive monitoring system 21 connected to the CNOT system 10 via TCP/IP. The passive monitoring system 21 may be a network of computer systems implemented as a processor which examines messages that pass through the STP 13. In particular, the passive monitoring system 21 may be a system that scans and detects when a specific mobile device number has registered and generates a triggering event that provides availability information to the servers 50, 70.

Alternatively, the passive monitoring system 21 may be a monitoring system, such as for example AGILENT acceSS7®, or INET Geoprobe®, in which registrations 12 may be received by the CNOT system 10. In an INET, message traffic may be monitored for availability producing events, such as registrations 12. In the INET, a plurality of probes or links may be placed at various locations in the SS7 network 20 which monitor message traffic. Information, such as registrations 12 and GSM MAP update location messages are monitored and availability (presence and location) about the mobile device 9 may be derived.

Operational Cycles

Various operational cycles may take place in the CNOT system 10 at different intervals which would require messages to be delivered to various mobile devices 9 with updated information, including but not limited to performing: daily loads; mass push downloads; daily logs; updated loads; and invoked delivery. “Daily loads” occur when new activations are needed and/or MIN changes generated by the markets are provisioned into the CNOT system 10, and then distributed to the passive server 70 platforms in the respective market. In other words, current IRDB's are downloaded to the subscriber daily.

“Mass push” to various mobile subscribers occurs when numerous subscribers require a change in their current IRDB file. For example, a mass push is desired when the profiles in the mobile device 9 do not match current profiles as a result of some new negotiated roaming partner arrangement implemented by a carrier. Consequently, current files are mass pushed down through the passive servers 70 to the mobile devices 9 distributed in each of the various markets. Mass push may be performed any number of times at any time throughout a day; for example, nightly by the central server 5 and then on the passive servers 7.

Delivery of a message may be designated by “invoked delivery.” Invoked delivery is performed by a virtual SMSC operating in either the active server 50 or the passive servers 70 that perform functions similar to an SMSC when processing IRDB downloads. The invoked delivery process reads the contents of the concerned database 54 into memory and sends an IS-41 SMS request message or a GSM MAP Send Routing Information for Short Message (SRIS) to the HLR 26 requesting availability of the mobile device 9. If the mobile device 9 is available in the market, it will download the message data via the IS-41 SMDPP (short message data point-to-point bearer service) or the GSM MAP Forward Short Message (FSM) message to the mobile device 9. However, if the mobile device 9 cannot be located, the central server 5 will forward the message to a passive server 70 so that when the mobile device 9 becomes available (or registers with the passive server 70) the passive server 70 will download the IRDB information to the subscriber. Other modes for delivery of a message, now known or later developed, are also possible alternatives in accordance with systems and methods of this invention.

An example of a change that would require a message to be delivered to the mobile device 9 for provisioning would be, for example, where a subscriber buys a new ERICSSON® phone (and previously had a MOTOROLA® phone). The subscriber's profile database 2 will be provisioned by some external source, such as the provisioning system 4 to reflect that change. The changes made to the subscriber profile database 2 will cause the central server 5 to generate and send a request to update information to the mobile device 9. A message will then be generated by the central server 5 and delivered to the active server 50 to determine availability and deliver the message to the mobile device 9. Additional operational cycles in which delivery of messages is required, now known or later developed, may also be performed in accordance with systems and methods of this invention.

Provisioning, activation, notification and registration are accomplished according to the various technology types. In addition to the description above, the following considerations are also made with respect to the OTA server 60.

OTA Server

The OTA server 60 (such as for example a SMART TRUST® server provided by SchlumbergerSema (www.schlumbergersema.com) is an over the air GSM encapsulated message delivery platform which assists in the delivery of information to a subscriber identity module (SIM) card. The OTA server 60 has the capability to convert information to be downloaded to the SIM card from the central server 5. In particular, the OTA server 60 writes to, or modifies, encrypted SIM cards which are stored in the mobile handsets 9 when provisioned changes occur in the CNOT system 10.

When availability information is received based on an echo registration 14 that matches a specific profile number, the central server 5 is notified of the availability. In response, the central server 5 generates a message and delivers the message to the OTA server 60. The OTA server 60 then processes the message and delivers it to the SIM card where it is encoded. Since the OTA server 60 has serious limitations on its ability to store messages, the message is not sent to the OTA server 60 until after availability information has been received about the mobile handset 9 so that unnecessary messages are not held in a the queue by the OTA server 60. This alleviates traffic and the storage of messages on the OTA server 60 because it is no longer necessary to store messages with the OTA server 60 for extended periods.

II. Active Server System Components/Features

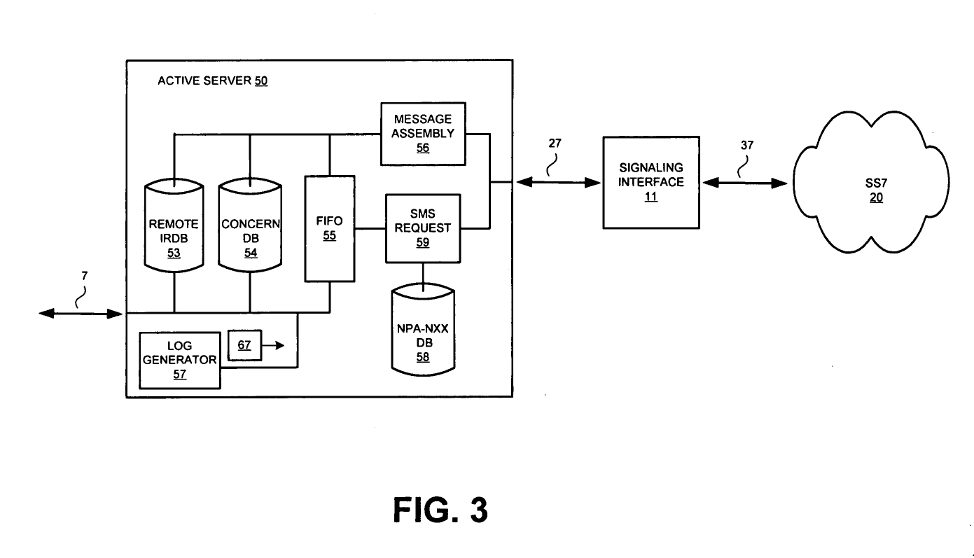

FIG. 3 shows one exemplary embodiment for the active server 50. The active server 50 includes a remote intelligent routing database (RIRDB) 53, a concerned database 54, a first-in-first-out database (FIFO) 55, a message assembly 56, an SMS request 59, an NPA-NXX database 58 and a log generator 57.

Signalling Interface

According to this exemplary embodiment, the active server 50 communicates with a signaling interface 11. For exemplary purposes only, the signaling interface 11 illustrates an IP communication link 27 in, and an SS7 communication link 37 out. Connectivity from the active server 50 (and/or passive servers 70) to the SS7 20 may communicate in a variety of modes, including by serial, IP, or by direct connection, for example, with a keyboard and a display. The SS7 communication link 37 may be implemented as low speed SS7 links.

The signaling interface 11 may be any type of commercially available gateway that is capable of communicating messages from the active server 50 over the SS7 20 to the MSC 24, such as an IP-SS7 gateway made by MICRO LEGEND®, CISCO®, TEKELEC®, TALI®, SIGTRAN®, and any other commercially available IP to SS7 converter. As mentioned before, the signalling interface 11 can support multiple protocols, either individually (such as for example only, IP connectivity) or various at a time (such as for example, IP and SS7 connectivity).

Remote Intelligent Routing Database (RIRDB)

The RIRDB 53 is a remote database in each of the remote servers 50, 70 that includes the information in the IRDB 15 of the mobile device 9. The RIRDB 53 contains current and past database lists. The RIRDB 53 includes subscriber profiles that are to be loaded into the customer's mobile devices 9. Each of the RIRDB's 53 is concerned with those customer profiles in each of the respective remote regional areas. For example, the customer profiles in an RIRDB 53 in a passive server 70 in Atlanta, Ga., would be directed to those customers in that particular market region. Alternatively, the RIRDB 53 could be a large database, including numerous customer profiles, such as a global database that serves all areas.

Concerned Database

The concerned database 54 is used to store details (such as, the MIN and the IRDB) of the message associated with a particular MIN for the mobile device 9 that is to be located and updated. For efficiency purposes, the actual message may be stored in RIBDB 53. Selected details of the message, such as the MIN, are held in the concerned database 54 until the particular mobile device 9 that matches the particular MIN (that requires an update) registers with the CNOT system 10. After the particular mobile device 9 registers, the MIN encoded in the received message is compared to the MIN's in the concerned database 45. If a match is identified, the message may be downloaded to the mobile device 9. This downloaded message data may contain various types of information, such as information provided to the mobile device 9 that indicates a preferred roaming carrier network on which to roam. Thereafter, an acknowledgement log file 67 message is generated by the log generator 57 and returned to the central server 5 indicating that the message has been received and the subscriber's profile has been updated. The return acknowledgement log file 67 message is then delivered and stored in the history database 3 of the central server 5.

First-In-First-Out Database (FIFO)

The FIFO 55 is a database where messages are sent via the communication link 7. The FIFO 55 is capable of receiving requests at any interval. Since there is a predetermined amount of bandwidth available on the SS7 20 (e.g., the typical SS7 link is a 56 K link, i.e. 56,000 bits per second), the number of messages that may be processed at one time is limited to one at a time. Therefore, the FIFO 55 is provided to organize the order in which the messages are processed. At times, a large number of message requests may be received, and other times, a lower number of requests may be received. As a result, the FIFO 55 organizes the message requests coming in, in a first-in first-out manner.

The FIFO 55 may be equipped with a time-out feature. The time-out feature is setup so that the longer the message sits in the FIFO 55, chances are greater that the mobile device 9 is not going to be located. For example, if the message sits in the FIFO 55 for one minute, the chances of locating the mobile device 9 are reasonably good. But if the message sits in the FIFO 55 for example 30 minutes, the mobile device 9 may no longer be turned on, or may no longer be in the cell, or the switch it was previously present and thus may not be located. As a result, the FIFO 55 may time-out. When a time-out occurs, a message may be sent to the central server 5 informing of the time-out and requesting additional instruction, such as instructions for rerouting the message to the passive server 70 for delivery, or canceling the request to locate the mobile device 9.

Message Assembly

The message assembly 56 assembles the message to be downloaded to the mobile device 9 when availability information about the mobile device 9 has been detected. The IRDB associated with the message is also pulled from the RIRDB 53 and sent through the FIFO 55 and are used to compile the message. In the message assembly 56, a message is generated based on the mobile identification number (MIN) and the IRDB coming from the FIFO 55. For example, in the message assembly 56, a binary message is built up as an SS7 message. The SS7 message is encapsulated in IP. The signaling interface 11 converts the IP message to an SS7 message.

SMS Request

The SMS request 59 and the active server 50 in combination with the central server 5 perform the functions of the SMSC 500. The SMS request 59 generates SMS requests when a message has been fed out from the FIFO 55 and before the message assembly 56 assembles a message. Before the message may be routed to the appropriate mobile device 9, an SMS request is generated and sent to the HLR 26 which requests a point code of the target mobile device 9. Accordingly, the active server 50 performs the functions of a conventional SMSC 500. As a result, the SMSC 500 can be bypassed.

NPA-NXX

The NPA-NXX database 58 is contained within the active server 50 and identifies where the subscriber's HLR 26 is located. For TDMA subscribers, this NPA-NXX database contains the point code of the subscribers HLR where we send the SMS request. The return result of the SMS request is the point code of the serving MSC.

In an ordered system, all 10,000 numbers of a 10,000 number block are contained within one NPA-XXX. That is, all 10,000 numbers are contained in the same HLR 26. However, the trend is moving away from operating in this ordered system and instead is moving toward operating in an unordered system. It is an object of the CNOT system 10 to be versatile and to operate in a variety of different environments. Namely, translations may be built into the STP 13 that examine those messages and properly route the message.

Log Generator

The log generator 57 generates a log file 67 that records various operating transactions that occur in the CNOT system 10. For example, the log generator 57 will generate a log file 67 based on the success or failure of an attempt to deliver a message. The log file 67 may be generated in real time or at predetermined intervals, such as ten-minute intervals. The log file 67 is sent out over the communication link 7 to the central server 5 and stored in the history database 3. The log files 67 may be recalled and reviewed at a later date.

Log File

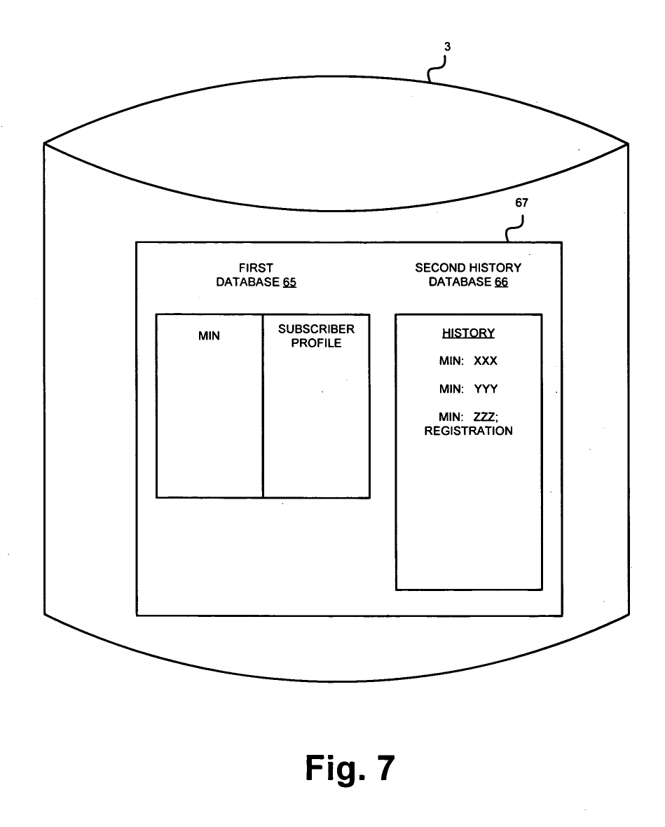

FIG. 7 illustrates an exemplary log file 67. Various types of information may be reported by the log file 67, such as the results of message deliveries attempts. For example, the log file 67 shows a history database 3 that includes a first database 65 that contains a MIN and a subscriber profile. The log file 67 includes a second history database 66 chronologically ordered that contains a history of the attempts to deliver a message for a particular target mobile device 9. In the second history database 66, a history of the particular target subscriber is recorded.

As shown in the second history database 66, a first entry indicates a first location (XXX) that the MIN of the particular target subscriber was previously located when an attempt to deliver a message was performed. A second entry indicates a second location (YYY) that the MIN of the particular target subscriber was previously located when another attempt to deliver a message was performed. The last entry indicates the last location (ZZZ) where the MIN of the particular target mobile device 9 was registered when another attempt to deliver a message was performed. Identifying the last location (ZZZ) of the MIN of the particular target mobile device 9 in response to a delivery attempt was not conventionally performed. According to systems and methods of this invention, this last entry (ZZZ) is added to assist the central server 5 in locating the availability of the mobile device 9. The last entry (ZZZ) may include various other types of information, such as a point code.

Operation

Referring back to FIG. 3. In operation, when a change is provisioned in the CNOT system 10, the central server 5 generates a message including provisioning instructions in response to that change. When immediate delivery of the message is necessary, the message is delivered via communication link 7 to the active server 50. The message comes into the holding database 54 with various types of information, such as the MIN and the instructions that are to be delivered. The message is loaded into the RIRDB 53 and into the FIFO 55. Pertinent identifying parts, such as the MIN and message are also delivered and loaded into the concerned database 54.

When the record is pulled out of the FIFO 55, an SMS request 59 is sent out to the SS7 20 network through the signaling interface 11, which converts the message to an SS7 format, and routes the message via the SS7 20 to the HLR 26 for the mobile device 9. The HLR 26 is queried for the availability of the particular mobile device 9. The HLR 26 returns the SMS request 59 response containing a point code of the serving MSC 24, or returns an unavailable message if the mobile device 9 cannot be located at the time the message is ready to be delivered.

If the point code for the serving MSC 24 is received, a message is built up and assembled in the message assembly 56 and routed to the particular mobile device 9. The message is then sent across the IP-SS7 converter 51 and out over the SS7 20 network and delivered to the mobile device 9.

However, if the point code is not received, or a message is received that says that subscriber is unavailable, the active server 50 may for example go back and delete the subscriber out of the concerned database 54 and send a message over communication link 7 back to the central server 5 indicating that the subscriber is unavailable and/or cannot be located.

The central server 5 may attempt to resend-that message several times. That is, the central server 5 may make a determination as to whether it should attempt the delivery of the message multiple times. For example, if the return message 61 is a “failure” and the central server 5 determines that the message is unable to deliver the message via active server 50, the central server 50 may try any number of times or may delay the delivery of the message. A counter (not shown) may be implemented in the CNOT system 10 to keep track of all of the attempts.

The counter may be set to delay the delivery attempts for a predetermined period of time between each attempt. The number of attempts is programmable and is determined based on logic in the central server 5. If the return result is successful, the log generator 57 generates a log file 67 that is delivered and recorded in the history database 3. Otherwise, if the return result is unsuccessful, the central server 5 makes a decision to forward the message for delivery to the passive server 70 serving the mobile device 9. The log generator 57 will also generate another log file 67 and deliver it to the history database 3 to be recorded.

III. Passive Server System Components/Features

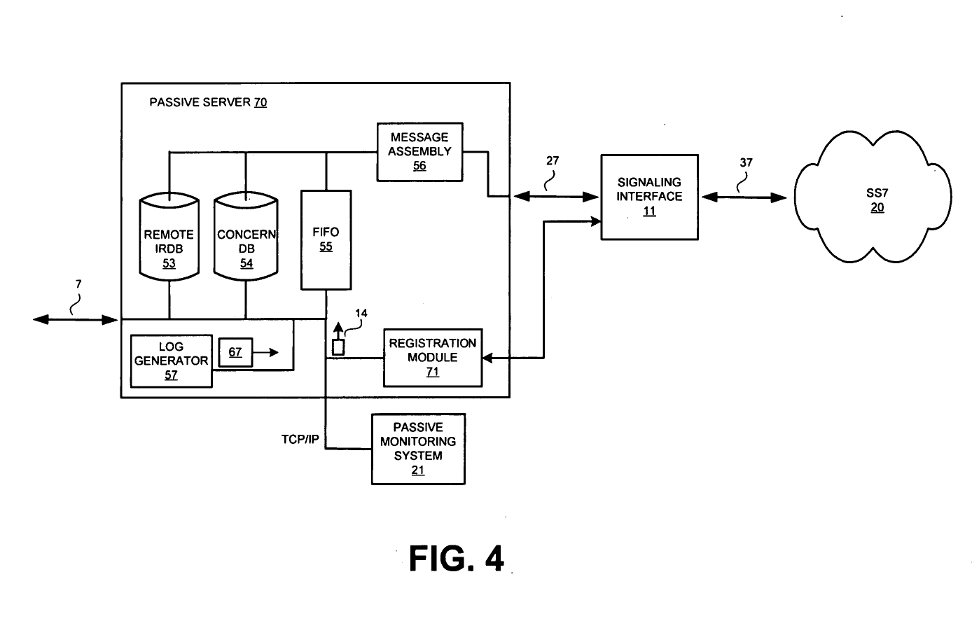

FIG. 4 shows an exemplary embodiment for the passive server 70 in accordance with systems and methods of this invention. The passive server 70 is similar to the active server 50 in terms of architectural layout with a slightly different technology built into it, as described below. In FIGS. 3 and 4, refer to like reference numbers for a description of similar components. Any other triggering event may be implemented for receiving registrations, such as receiving registrations from, the HLR 26, the passive monitoring system 21, directly from cell towers, and/or any other event now known or later developed from which availability of a mobile device 9 may be derived.

As shown in FIG. 1, the passive servers 70 are directed to various regional markets located around the country. The task of the passive servers 70 is to deliver messages to target mobile devices 9 as soon as the mobile device 9 becomes available, such as for example, as soon as the mobile device 9 registers with its HLR 26 and a triggering event notifies the CNOT system 10. However, although possible, the passive server 70 generally does not actively seek out the mobile device 9 like the process performed above with respect to the active server 50. Instead, the passive server 70 waits until a triggering event occurs that provides availability information about the mobile device 9.

CNOT Echo Registration and Logging Functions

Availability information from the CNOT system 10 may be received either actively or passively. The CNOT system 10 receives availability information about a mobile device 9, for example, when the mobile device 9 registers with the MSC 24 through a cell site, a message is sent back to the HLR 26 through the STP 13. The HLR 26 then sends return results back to the MSC 24. The HLR 26 also sends an echo registration 14 (or mobile registration trigger (MRT)) back to the CNOT system 10. According to systems and methods of this invention, it is also possible to obtain availability information from GSM update location information. The CNOT system 10 may also receive availability information about a mobile device 9 by passive monitoring systems 11 that passively monitor links in the network as mentioned above.

Registration Module

The registration module 71 shown in FIG. 4 passively detects echo registrations 14 produced from external triggering events. As mentioned before, triggering events from which an echo registration 14 can be derived may be received from various different network components in the system. The registration module 71 submits echo registrations 14 to the concerned database 54 and the FIFO 55 as described above.

According to the exemplary embodiment shown in FIG. 4, the passive monitoring system 21 is provided as the triggering event from which availability information may be derived. As mentioned before, the passive monitoring system 21 examines a copy of every message that passes through a particular location (such as at the STP 13) in the CNOT system 10. The passive monitoring system 21 extracts information and produces a triggering event from which an echo registration 14 is derived. The extracted information could include, for example, the MIN, the ESN and the point code.

It is an object of this exemplary embodiment to monitor echo registrations 14 (such as IS 41 registration messages) in order to determine the availability of a mobile device 9. Since every message is scanned by the passive monitoring system 21, messages of interest are extracted and shortened to a limited amount of information, such as for example, MIN, ESN, serving point code of the serving MSC 24 and/or any other pertinent information. The passive monitoring system 21 may be incorporated with, or separated from, the HLR 26 and the MSC 24.

Operation

As mentioned above, when a change is made by a provisioning system, the central server 5 generates a message in response to that change. When immediate delivery of the message is necessary (first delivery mode), the message is delivered via IP connectivity communication link 7 into the active server 50. However, if the active server 50 cannot locate the mobile device 9 at the time the message is ready to be delivered, the active server 50 may deliver the message to the passive server 70 for delivery (second delivery mode) at a later time. Alternatively, if the message does not need to be downloaded right away, the central server 5 may directly deliver the message (third delivery mode) to the passive server 70 for delayed delivery.

As mentioned before with respect to FIG. 3, the message is loaded into the RIRDB 53, and pertinent identifying parts, such as the MIN and IRDB are loaded into the concerned database 54.

When an incoming message (such as a registration 12) including a point code is received by the passive server 70, the message is fed into the FIFO 55. The passive server 70 compares the MIN of the incoming echo registration 14 with the MIN's stored in the concerned database 3. If the MIN of the incoming echo registration 14 matches a MIN in the concerned database 54, then the message is sent over to the message assembly 56 and the message assembly 56 builds a message to be delivered to the mobile device 9.

The message assembly 56 builds the message as mentioned before with respect to the active server 50. The difference from the active server 50 is that the message in the passive server 70 is built in response to the occurrence of a triggering event. According to this example, the triggering event is the mobile device 9 registering with the HLR etc. In addition, the message is assembled without performing a prior SMS request, as it is performed in the active server 50. This is different from the procedure in which the active server 50 actively attempts to deliver a message at the time the message is ready to be delivered by querying the HLR, regardless of whether a triggering event has occurred.

FIG. 5 shows an exemplary method for maintaining and managing over the air programming to a mobile device via a centralized notification system.

In step S100, a control routine begins. The control routine proceeds to step S200.

In step S200, a subscriber profile is modified. Changes to the subscriber profile are made in a central server. The subscriber profile may be changed in various ways different ways. Some of the various examples include, for example, the administration of changes to an intelligent routing database (IRDB), implementing provisioning system changes to the subscriber's profile, changes implemented by an accounting system server, and/or any other mechanism that is capable of making a change to the centralized notification system in accordance with systems and methods of this invention. The routine then proceeds to step S300.

In step S300, the central server generates and delivers a message including provisioning instructions to an active server. The active server actively seeks out and determines the availability of the mobile device to deliver the message as quickly as possible. New activation of a mobile device would be an example of where the active server would actively seeks out the availability of the mobile device so that new changes may be loaded into the mobile device as soon as possible to prevent delay of a subscriber's use of his new mobile device. The availability, is usually included in a registration. For example, the MSC currently serving the mobile device may be determined from the registration so that the instructions may be delivered to the mobile device. The routine then proceeds to step S400.

In step S400, the active server directly queries the HLR of the mobile device for the availability of the mobile device. The routine then proceeds to step S500.

In step S500, the routine determines whether the queried HLR has returned to the active server a message identifying the availability of the mobile device. Several query attempts may be made to the HLR when attempting to locate the availability of the mobile device. The attempts may be delayed and/or arranged at various intervals. After various unsuccessful attempts have been made to obtain positive availability information from the HLR, the central server forwards the message including the provisioning instructions to a passive server (step S900). However, if the HLR returns positive availability of the mobile device, the message is delivered to the mobile. The routine proceeds to step S600.

In step S600, the active server delivers the message including the provisioning instructions to the mobile device as soon as the mobile device 9 is located. That is, when availability information about the mobile device 9 is received, the active server builds and delivers the message to the mobile device and the mobile device is updated. The routine proceeds to step S700.

In step S700, results of the delivery attempts to deliver instructions to the mobile device are logged. Although shown at step S700, a log file including the attempt results for delivery may be created at any time throughout the process of the routine and logged. Results are logged in a history database that may be accessed later for review. The routine proceeds to step S800.

In step S800, the control routine ends.

As mentioned above in step S500, after various unsuccessful attempts have been made to obtain positive availability of the mobile device, the routine will proceed to step S900.

In step S900, the central server forwards the message to a passive server and the passive server then takes over the process of attempting to deliver the message to the mobile device. At least one regional passive server communicates with the central server. Various regional remotes may be located in various regional markets around the country and/or distributed worldwide. The control routine then proceeds to step S1000.

In step S1000, the passive server passively monitors message traffic in the network until a triggering event occurs that provides availability information about the mobile device. In response to receiving the availability information, the passive server delivers the message. In particular, as opposed to the active server which actively seeks out the availability of the mobile device, the passive server passively waits for the triggering event to occur, such as the mobile device registering with its serving MSC, before delivering the message to the mobile device.

The triggering event from which availability information about the mobile device is determined may be derived from a variety of different inputs, or feeds, arising from the various triggering events occurring in the centralized notification system. For example, an event could be comprised of monitoring individual cell towers or an STP for availability information. Availability information may also be captured from a triggering event that occurs within an MSC integrated with an HLR, e.g., a commercially available LUCENT® MSC/HLR unit. The triggering event could be related to intercepting location information data about a mobile device that is transmitted to, for example, an accounting server system in which the mobile device is tracked for purposes of billing. The triggering event could also be monitoring traffic between an MSC and an HLR to obtain a registration notification. The triggering event from which availability is determined is not limited to these examples and may be obtained by any other device feeding into the centralized notification system that is now known, or later contemplated, in accordance with systems and methods of this invention.

The control routine proceeds to step S1100.

In step S1100, the triggering event is captured that provides availability information about the mobile device. The availability information derived from the triggering event is automatically sent to the central server. It is an object of this invention to obtain availability information from a triggering event in the centralized notification system without having to query the HLR. As a result, the load on the SMSC is significantly reduced. The routine proceeds to step S1200.

In step S1200, the passive server delivers the message including the provisioning instructions to the mobile device. (In the alternative, a notification can be sent to the central server 5 prior to delivery of the message so that the central server can provide authorization and/or other additional information.) The routine proceeds to step S700.

In step S700, results of the delivery attempts to deliver instructions to the mobile device are logged into the history database. The routine proceeds to step S800.

In step S800, the control routine ends.

FIG. 6 shows an alternative exemplary method for maintaining and managing over the air programming to a mobile device via a centralized notification system. Moreover, in situations where there is not as immediate a need to locate the mobile device, such as where nightly mass downloads are to be delivered, or the mobile device cannot be located at the time the message is ready to be delivered because the mobile device is powered off, the following method for maintaining and managing over the air programming to a mobile device may be implemented via the centralized notification system. Many of the steps described in FIG. 6 function analogous to the process steps described in FIG. 5 and should also be referred to when gaining an understanding of the method steps described below.

In step S2000, a control routine begins. The control routine proceeds to step S2100.

In step S2100, a subscriber profile is provisioned. Changes to the subscriber profile are made in a central server. The routine then proceeds to step S2200.

In step S2200, the central server generates provisioning instructions in response to various changes implemented in the centralized notification system. The routine proceeds to step S2300.

In step S2300, the central server delivers a message including the provisioning instructions directly to a passive server. As mentioned above, the task of the passive server is to deliver the message in response to the occurrence of a triggering event from which the availability of the mobile device may be identified. At least one regional passive server is provided that communicates with the central server. Various regional remotes may also be located in various regional markets around the country and/or distributed worldwide. The control routine then proceeds to step S2400.

In step S2400, the passive server monitors message traffic in the network for a triggering event that provides availability information about the mobile device. Although possible, the passive server generally will not actively seek out the mobile device. Instead, the passive server waits for the occurrence of a triggering event, such as, the mobile device registering with the serving MSC before delivering the message to the mobile device. When a registration is received from the mobile device indicating the location of the mobile phone, a message is built and delivered to the mobile device. The triggering event from which availability information about the mobile device is determined may be derived from a variety of different inputs, or feeds, arising from the various events occurring in the centralized notification system, as described above with respect to FIG. 5. The control routine proceeds to step S2500.

In step S2500, the triggering event is captured that provides availability information about the mobile device. The availability information may be obtained without querying the HLR. The routine proceeds to step S2600.

In step S2600, the passive server downloads a message including the provisioning instructions to the mobile device and updates the mobile device. According to another alternative, a notification may be sent to the central server so that the central server can authorized and/or send additional instructions before the passive server delivers the message to the mobile device. The routine proceeds to step S2700.

In step S2700, results of the delivery attempts to deliver instructions to the mobile device are logged into the history database. The routine proceeds to step S2800.

In step S2800, the control routine ends.

One of ordinary skill in the art would understand that the steps described above in FIGS. 5 and 6 are not limited to any one particular order and may be implemented in any order that may achieve the objects and features described above in accordance with the systems and methods of this invention.

It is also to be understood that a carrier wave may be encoded to transmit a control program for use that includes the processes described above for the centralized notification system to a device for executing the control program.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A centralized notification system for over the air messaging, comprising:
a central server that generates a message to be delivered to a mobile device; and
an active server in communication with the central server that receives the message from the central server, the active server in communication with a network element that that communicates with the mobile device,
wherein the active server queries the network element to determine availability of the mobile device, wherein:
if the availability of the mobile device is returned from the network device, directly routing the message to the mobile device;
otherwise, routing the message to a passive server; and
wherein the passive server monitors message traffic for an event that provides availability information about the mobile device and automatically delivers the message to the mobile device in response thereto.

2. The centralized notification system recited in claim 1, further comprises logging results of the delivery of the message in a history database.

3. The centralized notification system recited in claim 1, wherein the availability is determined from an echo registration of a registration generated from a mobile device.

4. The centralized notification system recited in claim 3, wherein the echo registration is created and made available at a signal transfer point (STP).

5. The centralized notification system recited in claim 1, wherein the passive server receives the availability information about the mobile device without querying the HLR.

6. The centralized notification system recited in claim 1, wherein the message are created in response to various parameters, including implementing at least one of: administration changes to an intelligent routing database; a system change to a subscriber's profile; and changes by an accounting system server.

7. The centralized notification system recited in claim 1, wherein the central server generates and delivers the message to an active server in response to a new activation of a mobile device.

8. The centralized notification system recited in claim 1, wherein the at least one server includes multiple passive servers functionally servicing a geographic region.

9. The centralized notification system recited in claim 8, wherein the passive servers are distributed nationally.

10. The centralized notification system recited in claim 9, wherein the passive servers are distributed worldwide.

11. The centralized notification system recited in claim 1, wherein the event from which availability information is obtained is chosen from at least one of: monitoring individual cell towers; monitoring an STP; monitoring a server; and monitoring traffic between an MSC and an HLR.

12. A method for managing over the air programming to a mobile device, comprising:
generating a message in a central server that is to be downloaded to the mobile device;
delivering the message to an active server; and
querying a network element for availability information about the mobile device, wherein:
if the availability of the mobile device is positive, directly routing the message to the mobile device,
otherwise, routing the message to a passive server, wherein the passive server monitors message traffic for an event that provides availability information about the mobile device; and
downloading the message to the mobile device in response to receiving the availability information.

13. The method of claim 12, further comprises:
determining availability information from an echo registration that is automatically sent to the passive server, wherein the echo registration is a copy of a registration generated from a mobile device.

14. The method of claim 12, further comprises:
logging results of the delivery of the message in a history database.

15. A centralized notification system for over the air programming, comprising:
a central server that generates a message to be delivered to a mobile device; and
at least one passive server located in a region in which a mobile device is homed in communication with the central server that receives the message from the central server, the passive server in communication with a network element that communicates with the mobile device,
wherein the passive server monitors message traffic for an event that provides availability information about the mobile device and downloading the message to the mobile device in response thereto.

16. The centralized notification system recited in claim 15, wherein the availability is determined from an echo registration of a registration generated from a mobile device.

17. The centralized notification system recited in claim 15, further comprises logging results of the delivery of the message in a history database.

18. The centralized notification system recited in claim 15, receives the availability information about the mobile device without having to query the HLR.

19. The centralized notification system recited in claim 15, wherein the message can be created in response to various parameters, including implementing at least one of: administration changes to an intelligent routing database; a system change to a subscriber's profile; and changes by an accounting system server.

20. The centralized notification system recited in claim 15, wherein the central server generates and delivers the message to an active server in response to a new activation of a mobile device.

21. The centralized notification system recited in claim 15, wherein the at least one server includes multiple passive servers functionally servicing a geographic region.

22. The centralized notification system recited in claim 21, wherein the passive servers are distributed nationally.

23. The centralized notification system recited in claim 22, wherein the passive servers are distributed worldwide.

24. The centralized notification system recited in claim 15, wherein an echo registration is created and made available to a signal transfer point (STP).

25. The centralized notification system recited in claim 15, wherein the event from which availability information is obtained is chosen from at least one of: monitoring individual cell towers; monitoring an STP; monitoring a server; and monitoring traffic between an MSC and an HLR.

26. A method for maintaining and managing over the air programming to a mobile device, comprising:
generating a message in a central server that is to be downloaded to the mobile device; and
delivering the message to a passive server in a region in which the mobile device is homed,
monitoring message traffic for an event that provides availability information about the mobile device and automatically downloading the message in response thereto.

27. The method of claim 26, further comprising logging results of the delivery of the instructions in a history database.

28. A carrier wave encoded to transmit a control program usable for a centralized notification system to a device for executing the control program, the control program including instructions comprising:
instructions for generating a message in a central server that is to be downloaded to the mobile device;
instructions for delivering the message to an active server; and
instructions for querying a network element for availability information about the mobile device, wherein:
if the availability of the mobile device is positive, directly routing the message to the mobile device,
otherwise, routing the message to a passive server, wherein the passive server monitors message traffic for an event that provides availability information about the mobile device; and
instructions for downloading the message to the mobile device in response to receiving the availability information.

29. The method of claim 28, wherein the attempt to locate and deliver the message is performed by the first server in which an HLR is queried for a registration that provides availability information about the mobile device.

30. The method of claim 28, further comprises:
determining availability information from an echo registration automatically sent to the network element, wherein the echo registration is a copy of a registration generated from a mobile device.

31. The method of claim 28, further comprises:
logging results of the delivery of the message in a history database.

32. A carrier wave encoded to transmit a control program usable for a centralized notification system to a device for executing the control program, the control program including instructions, comprising:
instructions for generating a message in a central server that is to be downloaded to the mobile device; and
instructions for delivering the message to a passive server in a region in which the mobile device is homed,
instructions for monitoring message traffic for an event that provides availability information about the mobile device and automatically downloading the message in response thereto.

33. A method of updating an intelligent routing database (IRDB) in a mobile device, comprising:
generating a message to be delivered to a mobile device;
delivering the message to an active server; and
querying a network element for availability information about the mobile device, wherein:
if the availability of the mobile device is positive, delivering the message to the mobile device and updating the IRDB,
otherwise, routing the message to a passive server that monitors message traffic for an event to occur that provides availability information about the mobile device; and
delivering the message to the mobile device in response thereto.
